(19) United States
(12) Patent Application Publication
(10) Pub. No.: US 2015/0048938 A1
(43) Pub. Date: Feb. 19, 2015

(54) EXPIRATION OF PRODUCT MONITORING & INDICATING CIRCUIT

(71) Applicant: INOVIA LIMITED, Oxford (GB)

(72) Inventor: Steve Tew, Oxfordshire (GB)

(21) Appl. No.: 14/386,367

(22) PCT Filed: Mar. 19, 2013
(86) PCT No.: PCT/GB2013/050711

§ 371 Date: Sep. 19, 2014

(30) Foreign Application Priority Data
Mar. 19, 2012 (GB) 1204717.1
Oct. 22, 2012 (GB) 1218958.5
Nov. 22, 2012 (GB) 1221058.9

(51) Int. Cl. G08B 21/18

(52) U.S. Cl. CPC G08B 21/182
USPC 340/517

(57) ABSTRACT

A monitoring system for use with a perishable product. The monitoring system comprises a sensor assembly, an indicator, a user input, and a processor. The processor is configured to determine from 5 the output of the sensor assembly whether or not the perishable product has expired, and, in response to activation of the user input, to cause the indicator to indicate whether the perishable product has expired.

### FIELD OF THE INVENTION

The present invention relates to monitoring systems for perishable products. In particular, it relates to a label which indicates whether a product has expired or been exposed to adverse conditions.

### BACKGROUND

When a drug manufacturer makes a drug, or food manufacturer makes a food product, the product is put into a container and is then packaged and shipped. It may be shipped to another part of the country or another country, where the various ambient conditions will change. These ambient conditions in the supply chain journey can have an impact on the product. For example ice cream left above 0° C. for a certain amount of time will thaw the product and could affect the quality of the product or ruin it.

In another example, once a medicinal product has gone past its expiration date, medicinal products lose potency, many can become toxic and even deadly, and can cause more damage than good, especially if the product has been exposed to air, moisture, agitation, Ultra Violet light, lux and/or different temperatures through its life cycle or the supply chain. The medicinal product may be in the form of, for example, a liquid, cream, lotion, ointment, gel, liniment, balm, salve, solution, tablet etc.

For example, insulin should be stored at low temperature. When travelling overseas, insulin may not be kept in a low temperature environment for days or even weeks. Exposing insulin to high temperatures makes the insulin weaker and so it does not act as efficiently.

Many medicines lose strength and potency over time, or may react to prolonged exposure to light, heat, air and/or moisture. These reactions may not only cause the medicine to lose potency, but may also produce potentially harmful chemicals, or chemicals that interact with other medications in different ways to the original medicine. Medications in liquid dosage form may actually increase in strength past the printed expiration date because some components of the liquid can evaporate, leaving more of the active ingredient. Outdated medicines may no longer be sterile and could possibly lead to an infection or irritation if applied to sensitive areas (for example eye drops or ear drops).

For example, when aspirin is stored in the bathroom medicine cabinet, the prolonged exposure to moisture in the air makes the active ingredient in aspirin convert to acetic acid, this is why old aspirin smells like vinegar. As a further example, tetracyclines (“broad-spectrum” antibiotics used to treat a wide variety of bacterial infections) become dangerous past their expiration dates; expired tetracyclines can cause serious damage to the kidneys.

The loss of potency of an expired medicine becomes a major issue when the patient is using a maintenance drug such as an inhaler or a cholesterol-lowing prescription. The medication loses its effectiveness and can place the user in an unhealthy situation. Would anyone want to take expired medication for sever cardiac arrhythmia?

### PRIOR ART

WO03096309 relates to a method of judging the storage condition of food and beverage, etc. during distribution in a simple and objective manner; and an indicator therefor. This method is based on a technique comprising enclosing and sealing a dye component containing a pH colour changeable dye having its pH value adjusted together with a micro-organism derived from food and beverage in a sealed transparent container of synthetic resin or transparent small bag of soft film and judging the quality of low-temperature preservation of food and beverage, etc. on the basis of the degree of colour change attributed to the action of the dye component.

JP9101382 Provides a time indicator indicating the term of validity of medicine and the like with a constitution capable of exactly indicating the term of validity regardless of the environmental conditions of the surroundings during the use and capable of easily adding the indication to a container vessel of medicine and the like or its impregnation body. Disclosed is a flattened small external case fixed on a container vessel or a body impregnated with medicine and the like, containing an electronic system indicating the elapsed time with digits on a liquid crystal screen by electrically controlling the oscillator signal of an oscillator. This electronic system comprises a frequency divider, a counter device, an IC provided with a drive system, and the like, a battery and a power source switch.

WO2007117273 discloses a device for monitoring one or more of integral value of time and temperature, UV light exposure and a pre-determined temperature of an item. The device is useful for monitoring items or materials which are sensitive to time and temperature, UV light and/or a pre-determined temperature.

The disclosure is directed towards radiation sensitive devices such as self-indicating instant radiation alert dosimeters (SIRAD) can be accidentally, inadvertently or intentionally over exposed to time-temperature, UV light and a pre-determined higher temperature. Such over exposure can provide a false positive or false negative signal. A device based on polymerization of diacetylenes and melting of partially polymerized diacetylenes, both of which are associated with colour changes, is proposed as false positive, false negative, and tamper indicator.

The cited time/temperature indicators use various methods to indicate a product's validity, some using chemical reactions, which can be unreliable, or in the case of JP9101382, an electronic system that does not take into account outside environmental conditions the product may be exposed to.

The issue with current indicating technologies is that they are designed to monitor a products efficacy during the delivery phase only, for example when it's picked up from the manufacturer and delivered to the pharmacy or medical professional. Current monitoring technologies monitor a batch of products in a container rather than individual products inside the container and the monitoring is usually only done for part of the supply chain. The current invention monitors the individual product from bench to patient and it may also be used to monitor batches of products in a container.

### SUMMARY

According to a first aspect of the present invention, there is provided a monitoring system for use with a perishable product. The monitoring system comprises a sensor assembly, an indicator, a user input, and a processor. The processor is configured to determine from the output of the sensor assembly whether or not the perishable product has expired, and, in response to activation of the user input, to cause the indicator to indicate whether such conditions have occurred.

According to a second and third aspect of the present invention, there is provided a label and container comprising the monitoring system of the first aspect.

According to a fourth aspect of the present invention, there is provided a method of applying a monitoring circuit according to the first aspect to a container, wherein the monitoring circuit is initially unprogrammed, and is programmed with data immediately prior to being applied to the container.

### DESCRIPTION OF THE DRAWINGS

FIG. 1 is a schematic representation of a monitoring system according to the present invention;

FIG. 2 is an example of the monitoring system of FIG. 1 incorporated into a label or container for a product.

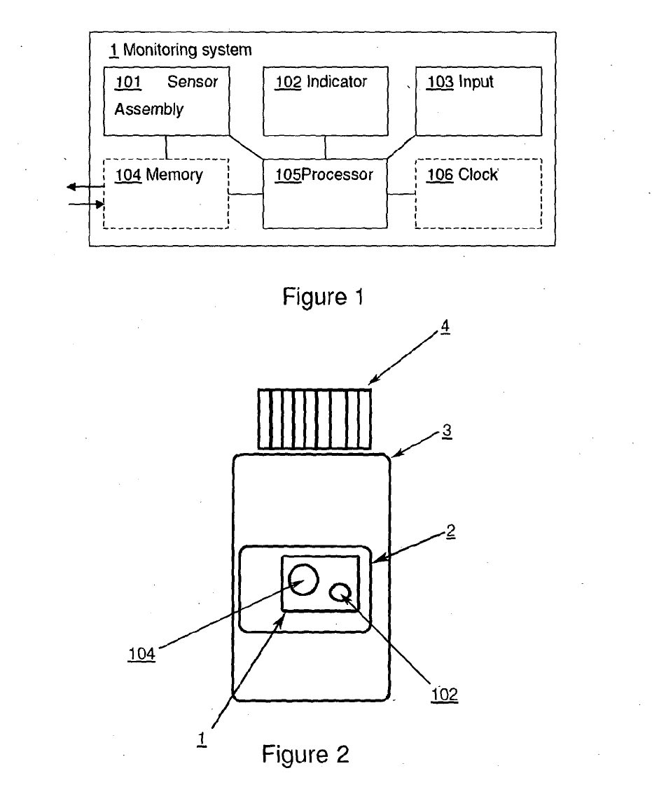

### DETAILED DESCRIPTION

A monitoring system 1 for perishable products is proposed. The monitoring system 1 may be included in a label 2 for the product, or otherwise included in the container 3 or packaging for the product. The monitoring system 1 comprises a sensor assembly 101 comprising at least one sensor, an indicator 102, a user input 103, and a processor 105. The processor monitors the output from the sensor, and determines if the product has expired from the output of the sensor assembly and the rules. When the user activates the input, the indicator provides an indication as to whether the product has expired.

The user activation input may, for example, be a button or touch sensitive region such as a capacitance pad, or a sensor that detects when the container to which the monitoring system is attached is opened (e.g. when a lid 4 is removed).

Examples of sensors used include temperature sensors, light sensors (including those sensitive to only certain bands of light, e.g. UV light), accelerometers, moisture sensors, and sensors to detect when a container has been opened.

The indicator may be any of an audio, visual, or haptic indicator. Audio indicators may include buzzers or speakers. Visual indicators may include lights (e.g. LEDs), display units (e.g. liquid crystal displays or electrophoretic “E-paper” displays), or colour changing elements. Haptic indicators may include vibration motors.

The indicator may only activate if the product is safe to use (i.e. has not experienced any adverse conditions), or it may have multiple activation states, one indicating that the product is safe, and another indicating that it is unsafe. For example, an audio indicator may have one tone to denote a product that is safe to use, and a second tone to denote a product that is unsafe. A visual indicator may show in one colour to indicate a product is safe, and a second colour to indicate that it is unsafe. The indicator may be arranged to activate only if the product is unsafe. However, the aforementioned alternatives are preferable, as if the indicator only activates if the product is unsafe, a failure of the system could cause the user to believe that the product is safe when it has expired.

Where the indicator is capable of displaying information (e.g. an LCD or E-Paper display), the indicator may provide information such as a list of any undesirable events, or the time remaining until expiration of the product. Such a display may also be used to provide more detail about the time to expiry. The indicator on the display could be a barometer style indicator that has a message hidden or partially hidden from view, the barometer or indictor could be a countdown to expiration, once expiration has been reached the display is clear to allow the message behind, middle or in front to show “DISCARD” or a similar message or image in black or white or colour. This could also act as a failsafe in case the power to the system fails, as the display will then immediately show the message or image as described.

The monitoring system may comprise a clock 106, and the processor may determine that the product is unsafe based on the time since the system was initiated. The monitoring system may store a threshold time since initiation at which the product expires, and may adjust this time in response to exposure to adverse conditions. For example, if a jar of ointment is left open for several days, the time until expiry may be reduced by several weeks.

The processor has a set of rules to determine when the product has expired (or become unsafe). These rules are ideally based on known data for the product, for example:
Thermal stress analysis
   This will give data allowing upper and lower temperature limits to be calculated
Oxidation rate and effect information
   This will allow an upper limit for the allowed air exposure to be calculated
Effect of moisture
Effect of agitation or motion
Effect of light (including specific wavelengths such as UV)
Date of manufacture
Expiry date (relative to date of manufacture)
   The processor may reduce the stored expiry date in response to adverse conditions.

An example set of rules for the monitoring system may be:

The product has expired if:
More than 2 years has passed since the initiation of the system
The temperature has exceeded 30° C. for more than 30 minutes
The product has been exposed to a humidity above 85% or
The container has been open for more than 20 hours total

Alternatively, each rule may specify a reduction in the time until expiry of the product. For example:
Initial time to expiry: 2 years
Each time the temperature exceeds 30° C., time to expiry is reduced by 1 week
For each hour the lid is left open, time to expiry is reduced by 1 day
If the humidity in the container exceeds 90%, time to expiry is reduced to 0

The rules may also be based on the time-integrated value of the sensor outputs (e.g. the area under the output vs. time curve, or the area of the curve above a certain output value).

The monitoring system will have at least the appropriate sensors to detect any quantities specified in the rules. In this example, the monitoring system would have at least a clock, a temperature sensor, a humidity sensor, and a sensor which can determine if the container is open.

The processor may constantly monitor the sensors and clock, and set a flag in memory when the condition of one of the rules is met. When the input is activated, the processor checks for the flag to determine if the product has expired, and which indication the indicator should give.

Alternatively, the output of the sensors may be logged in the memory, and the log compared to the rules when the input is activated to determine if the product has expired. This alternative will require more storage in memory, and may cause a noticeable lag between the activation of the input and the indication. The memory required can be reduced by only storing events where the sensor output is above (or below) a threshold value.

The processor may be implemented as an electronically erasable programmable read only memory (EEPROM) integrated system or other programmable integrated system (PIC) such as that made by Microchip™

The monitoring system may log data in a memory 104. This data can include a complete history of the sensor information, or details of any events where the sensor outputs exceed a threshold value, including a timestamp and details of the sensor outputs. This allows the cause of expiry to be identified, e.g. to determine if the product is being improperly handled during shipping, improperly stored between manufacture and delivery to the patient, or improperly stored by the patient. The data information may be obtained, for example, via a connector for a wired connection to a computer, e.g. USB or micro USB, via a wireless connection such as RFID or NFC, or via a display on a display unit, which may be in the form of a computer readable graphic such as a QR code, or a human readable output.

The monitoring system may be initiated by a machine, for example a machine applying a label including the monitoring system. The switch may be mechanical or electronic. When the label leaves the labelling machine, the monitoring device is activated, data logging from the sensors begins, and the clock begins counting. The monitoring system may be provided programmed for the product it relates to, or generic unprogrammed systems can be provided, which are programmed by either a wired or wireless connection (e.g. RFID or NFC) before being applied to the product. This programming includes setting the rules for the processor.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. A monitoring system for attachment to a container containing a perishable product, the system comprising:
a sensor assembly;
an indicator;
a user input;
a processor configured to determine from the output of the sensor assembly whether or not the perishable product has expired, and, in response to activation of the user input, to cause the indicator to indicate whether the perishable product has expired.

2. A monitoring system according to claim 1, wherein the sensor assembly comprises one or more of:
a temperature sensor;
a light sensor;
an ultraviolet light sensor;
a moisture sensor;
a motion sensor; and
a sensor configured to detect the opening of a container in which the product is stored.

3. A monitoring system according to claim 1, wherein the user input is any one of:
a button;
a touch sensitive input; and
a detector for detecting the opening of a container.

4. A monitoring system according to claim 1, wherein the indicator (102) is any of:
a visual indicator;
a light emitting diode, LED;
a liquid crystal display, LCD;
an audio indicator;
a buzzer;
a speaker;
a sounder;
a haptic indicator;
a vibration motor.

5-6. (canceled)

7. A monitoring system according to claim 1, wherein the conditions under which the processor considers the product to have expired can be accessed and modified by some other device via an interface.

8-10. (canceled)

11. A monitoring system according to claim 1, wherein at least some of the outputs of the sensor assembly are stored in a memory and the processor performs the step of determining whether or not the perishable product has expired from the stored sensor assembly outputs in response to the user input (103) being activated.

12. A monitoring system according to claim 1, wherein the processor is configured to set a flag in the memory in response to determining that the perishable product has expired, and the processor is configured to check the flag in response to the user input being activated.

13. A monitoring system according to claim 1, wherein the processor considers the product to have expired if the output from one or more sensors of the sensor assembly exceeds a threshold value.

14. (canceled)

15. A monitoring system according to claim 1, wherein the system comprises a clock and the processor considers the product to have expired when the clock indicates a certain time.

16. A monitoring system according to claim 15, wherein the processor is configured to modify the certain time dependent upon the output of the sensor assembly.

17. A monitoring system according to claim 1, wherein the processor is configured to calculate the time-integrated output of each of one or more sensors of the sensor assembly, and the processor considers the product to have expired if the time-integrated output of the sensor exceeds a threshold value.

18. A monitoring system according to claim 1, wherein the processor considers the product to have expired if the output of one or more sensors of the sensor assembly exceeds a threshold value for more than a threshold time period.

19. A label for a container for a perishable product, the label comprising the monitoring system of claim 1.

20. (canceled)

21. A method of applying a monitoring circuit according to claim 1 to a container, wherein the monitoring circuit is initially unprogrammed, and is programmed with data immediately prior to being applied to the container.

22. A method according to claim 21, wherein the data comprises any one or more of:
data about the perishable product;
conditions for expiry of the product;
the time at which the application of the 5 label occurs; and
instructions to initiate monitoring by the monitoring system.

23. (canceled)
